(19) United States
(12) Patent Application Publication
(10) Pub. No.: US 2004/0234030 A1
(43) Pub. Date: Nov. 25, 2004

(54) Method and apparatus for x-ray diffraction analysis

(76) Inventors: Jesse R. Miller, W. Lafayette, IN (US); Barbara C. Stahly, West Lafayette, IN (US); Leonard J. Chyall, Lafayette, IN (US); Igor Ivanisevic, W. Lafayette, IN (US); Simon Bates, W. Lafayette, IN (US)

Correspondence Address: Michael B. Harlin, McAndrews, Held & Malloy, Ltd., 34th Floor, 500 West Madison Street, Chicago, IL, 60661, US

(21) Appl. No.: 10/731,300

(22) Filed: Dec. 8, 2003

Related U.S. Application Data
(60) Provisional application No. 60/431,544, filed on Dec. 6, 2002.

(51) Int. Cl. G01N 23/20

(52) U.S. Cl. 378/79

(57) ABSTRACT

The present invention relates to a method and apparatus for X-ray diffraction analysis. An improved sample holder is provided that includes a curved surface or a plurality of surfaces at different planes. An improved sample holder also has removable individual sample holders.

### CROSS-REFERENCE TO RELATED APPLICATIONS

This application claims the benefit under 35 U.S.C. §119(e) of U.S. Provisional Application No. 60/431,544, filed Dec. 6, 2002. The '544 application is incorporated by reference herein.

### FIELD OF THE INVENTION

The present invention relates to a method and apparatus for X-ray diffraction analysis.

### BACKGROUND OF THE INVENTION

Sample holders for x-ray diffraction analysis are disclosed in U.S. Pat. No. 4,678,340 (Boese), U.S. Pat. No. 5,127,039 (Hesch) and U.S. Pat. No. 5,390,230 (Chang), each of which is incorporated by reference herein.

### SUMMARY OF THE INVENTION

The present sample holder has a curved surface and/or multiple planes and/or removable individual sample holders, thereby facilitating the analysis by x-ray diffraction of a relatively large number of samples. The present sample holder can keep the x-ray source and detector relatively close together.

In one aspect, a method of analyzing samples by x-ray diffraction analysis is provided, wherein the samples are presented for analysis on multiple planes. An apparatus for x-ray diffraction analysis is also provided, wherein the apparatus comprises surfaces for holding the samples on multiple planes.

In another aspect, a method of analyzing samples by x-ray diffraction analysis is provided, wherein the samples are presented for analysis on a curved surface. An apparatus for x-ray diffraction analysis is also provided, wherein the apparatus comprises a curved surfaces for holding the samples.

### BRIEF DESCRIPTION OF THE FIGURES

FIG. 1 is a drawing of a plate 10 of a multi-plane sample holder for x-ray diffraction analysis.

FIG. 2 is a drawing of a frame 20 having a plurality of individual sample holders 22 for x-ray diffraction analysis.

### DETAILED DESCRIPTION OF PREFERRED EMBODIMENTS

In one embodiment, the present sample holder permits X-ray diffraction analysis of two or more samples on two or more planes. The relative angle(s) of the planes is preferably between 0.1 and 20 degrees. The multi-plane sample holder provides several advantages. One advantage is that the design allows the x-ray source and detector to be relatively close together. This allows for a relatively larger sample holder on a compact x-ray system. The close proximity of source to detector also minimizes x-ray absorption by the air, which is a consideration in x-ray fluorescence. The arrangement also increases the 2 theta range measured by the detector. Another advantage of the present sample holder is that a larger portion of the stage can be accessed relative to use of a single-plane holder. The samples can be placed a certain distance apart to minimize interference from adjacent samples. Samples can be placed on the planes themselves, in wells in the planes, or in sample holders that rest on or are attached to the planes.

The multi-plane surface could be a diffractometer stage, a block that is placed on the stage as in Example 1, a plate that is placed on the block, or a frame that is placed on the block and has individual sample holders in it. For each surface (stage, block, plate, individual sample holder), the samples could be placed directly on the surface, in wells defined by the surface, or in secondary containers on the surface.

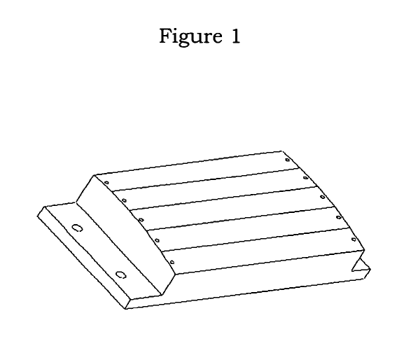

A sample holder 10 for X-ray diffraction having two or more planes 12 is shown in FIG. 1 as an example. Samples can be placed directly on the sample holder's planes, in wells in the planes, or in some kind of secondary holder such as a capillary or a silicon square with a well in it. Some advantages of employing removable individual sample holders are described below.

In another embodiment, the present sample holder has a curved surface, and X-ray diffraction analysis is performed on two or more samples on the curved surface. Utilizing a curved surface can increase flexibility in the scan range, permit use of a larger portion of the stage than with a single-plane holder, and minimize interference from adjacent samples. The samples can also be placed a certain distance apart to minimize interference from adjacent samples. The samples can be placed on the curved surface itself, in wells in the curved surface, or in sample holders that rest on or are attached to the planes. The relative angles of the planes preferably between 0.1 and 20 degrees.

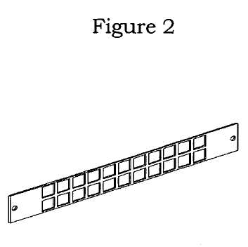

In yet another embodiment, the present sample holder for X-ray diffraction analysis of two or more samples comprises a frame having removable individual sample holders. The use of individual holders allows sample loading away from samples already in the frame thereby reducing the risk cross contamination and spillage. The individual holders can be any appropriate size. For example, they could be 8 mm wide, 8 mm long, and 2 mm thick. Individual holders can be any appropriate shape. For example, they could be round, square, or rectangular. The individual holders can be any appropriate material of construction including plastic, metal, and glass. For example, they could be aluminum, silicon, quartz, glass, or Kapton™ brand polyimide or another polyimide. The individual holders can be used with sample placed directly on them or within a well in the individual holder. The individual holders used could be a mixture of different sizes, shapes, and materials. If there are wells in individual holders the wells can be any appropriate size, such as 2 mm wide, 2 mm long, and 0.5 mm deep. Wells in the individual holders can be any appropriate shape, such as hemispherical or conical. The frame could be a perimeter that individual holders fit within, or the frame could be a surface which has depressions or holes within which the individual holders rest or an adhesive or other means could be employed to restrict movement of the individual holders. The frame could be a grid, for example, as shown in FIG. 2. The frame could be a grid attached to a plate so that individual holders could be loaded separately then the set of individual holders could be transferred to its place within the frame. Alternatively the frame could be a block with wells or depressions appropriate to hold the individual holders.

In another embodiment, the present sample holder for X-ray diffraction analysis of two or more samples comprises a frame that has a multi-plane surface (“multi” meaning two or more) with removable individual sample holders. The frame may be of a design and character as set forth above. The use of removable individual holders has the advantages set forth above. The individual holders can be any size, or appropriate material of construction, including plastic, metal, glass, such as aluminum, silicon, quartz, glass, or Kapton™ brand polyimide or another polyimide. The individual holders can be used with sample placed directly on them or within a well in the individual holder. The individual holders used could be a mixture of different sizes, shapes, and materials.

The individual sample holders can be placed directly on the planes. The frame could be a grid that is sized to fit on one plane or it could be a multi-planar grid designed to fit more than one plane or to fit the entire surface.

The frame could be a grid attached to a plate so that individual holders could be loaded separately then the set of individual holders could be transferred to its place within the frame. Alternatively the frame could be a block with wells or depressions appropriate to hold the individual holders.

In some embodiments, as alternatives to removable grids and removable inserts that go into grids, one may machine sample wells directly into a block on separate tiers. One may also machine sample wells into removable grids.

As another embodiment a sample holder for X-ray diffraction analysis of two or more samples has a multi-plane surface (“multi” meaning two or more) and a removable piece or pieces that fit on the planes of the sample holder. The samples could be placed directly on these pieces, could be placed in wells in the pieces, or could be in a secondary holder like a capillary or a silicon square with a well in it. The characteristics and advantages of a frame with removable individual sample holders are set forth above.

Furthermore, there could be a piece sized to fit each plane or there could be a multi-planar piece designed to fit more than one plane or to fit the entire surface. The piece could be attachable to the sample holder so that pieces could be loaded separately, then the set of pieces cold be transferred to its place within the sample holder.

The samples in individual sample holders or pieces may be in or on the sample holder or pieces, and can be covered with a protective film to minimize movement of the powders and reduce risk of cross contamination. For example, a powder sample could be secured with a small piece of transparent tape or with another polymer film with adhesive on one side. Alternatively, a plurality of samples could be covered by one or more pieces of film. The diffraction analysis could be done with the film in place. Any diffraction peaks from the film that interfere with analysis could be subtracted from the data. Alternatively a low-diffracting film could be used, such as polypropylene, or Kapton™ brand polyimide or another polyimide could be used.

Preferably a multi-plane sample holder has the footprint of a standard microtiter plate (see Example 2). This would allow, for example, all 96 positions of sample deposits resulting from use of a standard 96-well format to be analyzed automatically from 5 to 40 2 theta without danger of the source colliding with the stage, with the holder, or with samples on the holder. Furthermore, the sample holder could be used for plate formats with any number of wells.

The present methods and apparatus may be used with any suitable x-ray diffraction instruments or detectors. Furthermore, the present methods and apparatus may be integrated with LIMS, or utilized standards during analysis, or special software that works with instrument software to start scans and do data analysis.

### EXAMPLE 1

In this example, the present sample holder comprises a series of surfaces oriented at nonzero angles relative to one another. In order to see low angle diffracted radiation, the source must be positioned at an angle that is less than or equal to the desired diffraction angle. For example, if one would like to see a 2θ (diffraction angle) value of 7°, the source angle, θ1, must not be greater than 7°. As another example, if one would like to see a 2θ (diffraction angle) value of 5°, the source angle, θ1, must not be greater than 5°. Since many compounds have “low theta peaks”, it is preferable to have the capability to detect such peaks. It is also useful to see higher angle diffracted radiation during the same analysis. A preferable range is approximately 5° to 40° 2 theta. Measuring to these low angles while maintaining a wide angle measurement range increase the probability of collision between the sample stage and x-ray optics.

A diffractometer stage is typically simply a flat surface. For example, the Bruker D-8 Discover x-ray diffractometer stage is a flat surface. If one attempted to use the entire 100 mm by 100 mm testing surface (as allowed by the x and y limits of the stage driving mechanism) at angles from approximately 5° to 40° 2 theta, the source itself would collide with the stage. In order to utilize as much of the testing surface as possible while maintaining a low source angle, a modification of the existing surface is desired.

The present multi-tier sample holder accomplishes the aim of utilizing more of the testing surface. In the present example, the sample holder comprises five angled surfaces that each holds a number of samples. On each of the five surfaces, the source and detector are positioned at angles relative to the inclination of that tier, such that the effective source angle “seen” by the sample is low enough to observe the low theta peaks requested in the detector. Then, as the holder is traversed across the x-direction, the source and detector angles change because the surface tier angle changes. θ1 and θ2 are positioned identically relative to each tier the test is conducted on, but in an absolute frame of reference they change for each surface.

The present sample holder allows analysis of up to 110 samples at a time. It includes two parts, a base plate and a sample holder grid. For each sample holder assembly, there are 5 sample holder grids and 1 base plate, because 1 grid fits on each tier. The base plate consists of a block, which has a top surface that has been fashioned into 5 surfaces at nonzero angles relative to each other. It also has “wings” 14 on both sides having holes 16 that accommodate screws to secure it into position onto the Bruker stage. It is shown in FIG. 1.

The sample holder grids have square cuts 22 in a regular pattern to hold samples or sample holders. They also have holes 24 on both ends so that a screw can fit through them and into a corresponding hole on the top of the base plate (for example, holes 18 in FIG. 1) to affix them there. One of the sample holder grids is shown in FIG. 2.

### EXAMPLE 2

In this example, a base plate is provided with approximate dimensions of 128 mm long, 86 mm wide, and 14 mm thick at the thickest point is tapered to provide a two-plane top surface. One plane is horizontal and one plane is angled five degrees down with respect to the horizontal plane. Approximate dimensions of each plane are 128 mm long and 43 mm wide. In other embodiments, the approximate dimensions of each plane may be 64 mm long and 43 mm wide. A set of 96 powder samples is disposed on the planes, making a 4×12 array on each plane. Automated X-ray powder diffraction can then be carried out for all samples. Without the multi-plane design, it is estimated that, for example, a Bruker D-8 Discover microdiffractometer would be able to analyze only about 77 samples from 5 to 40 degrees 2 theta.

What is claimed is:

1. A sample holder for x-ray diffraction analysis, said sample holder comprising a plurality of surfaces oriented at nonzero angles relative to one another.

2. A sample holder for x-ray diffraction analysis, said sample holder comprising a curved surface suitable for holding samples.

3. A sample holder for x-ray diffraction analysis, said sample holder comprising a plurality of removable individual sample holders.

4. A method of x-ray diffraction analysis comprising the step of disposing samples in the sample holder of claim 1, and analyzing the samples.

5. A method of x-ray diffraction analysis comprising the step of disposing samples in the sample holder of claim 2, and analyzing the samples.

6. A method of x-ray diffraction analysis comprising the step of disposing samples in the sample holder of claim 3, and analyzing the samples.
